(19) United States
(12) Patent Application Publication
(10) Pub. No.: US 2019/0141620 A1
(43) Pub. Date: May 9, 2019

(54) SELECTIVE SCANNING BASED ON SHARED SCANNING INFORMATION

(71) Applicant: QUALCOMM Incorporated, San Diego, CA (US)

(72) Inventors: Sunit PUJARI, Hyderabad (IN); Imran Ansari, Hyderabad (IN); Sougat Ray, Hyderabad (IN); Hemant Kumar Sahoo, Hyderabad (IN)

(21) Appl. No.: 15/806,038

(22) Filed: Nov. 7, 2017

(51) Int. Cl. H04W 48/16

(52) U.S. Cl. CPC H04W 48/16; H04W 88/08

(57) ABSTRACT

This disclosure provides systems, devices, apparatus and methods, including computer programs encoded on storage media, for receiving scanning information from a second wireless communication device over a wireless link associated with a first wireless communications protocol, the scanning information identifying one or more wireless frequency channels associated with a second wireless communications protocol; selecting a subset of wireless channels associated with the second wireless communications protocol based on the scanning information; and scanning one or more wireless frequency channels of only the selected subset of wireless frequency channels. This disclosure also provides systems, devices, apparatus and methods, including computer programs encoded on storage media, for scanning a plurality of wireless frequency channels in one or more frequency bands associated with one or more first wireless communications protocols; identifying a subset of the plurality of scanned wireless frequency channels on which one or more access points are operating; and transmitting scanning information including the identified subset of wireless frequency channels to a second wireless communication device over a wireless link associated with a second wireless communications protocol.

### TECHNICAL FIELD

This disclosure relates generally to wireless communications, and more specifically, to selective scanning of available wireless channels based on shared scanning information obtained via neighboring wireless devices.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or maintain a communication link with the WLAN. In a typical WLAN, each STA may be associated with only one AP at a time. As a result of the increasing ubiquity of wireless networks, a STA may have the opportunity to select one of many WLANs within range of the STA and/or select among multiple APs that together form an extended BSS. After association with an AP, a STA also may be configured to periodically scan its surroundings to find a more suitable AP with which to associate. For example, a STA that is moving relative to its associated AP may perform a “roaming” scan to find an AP having more desirable network characteristics such as a greater received signal strength indicator (RSSI).

To identify an AP with which to associate, a STA is configured to perform scans on the wireless channels of each of one or more frequency bands (for example, the 2.4 GHz band and/or the 5 GHz band). Scans may be passive or active. A STA may perform a passive scan on a given channel by spending a duration of time on the channel so that it can receive any beacons that are periodically broadcast by APs within range and operating on that channel. A STA may alternatively perform an active scan on a given channel by transmitting a probe request to trigger probe responses from APs within range and operating on that channel. A STA may spend a considerable length of time to complete a comprehensive scan of the available wireless channels. Because scanning operations may consume a significant amount of power, it is desirable to reduce power consumption associated with scanning operations. Additionally, because scanning operation may consume a significant amount of time, it is desirable to reduce the amount of time spent scanning to increase the performance of the wireless device.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method includes receiving, by a first wireless communication device, scanning information from a second wireless communication device over a wireless link associated with a first wireless communications protocol, the scanning information identifying one or more wireless frequency channels associated with a second wireless communications protocol. The method also includes selecting, by the first wireless communication device, a subset of wireless channels associated with the second wireless communications protocol based on the scanning information. The method additionally includes scanning, by the first wireless communication device, one or more wireless frequency channels of only the selected subset of wireless frequency channels.

In some implementations, the first wireless communications protocol is based on a Wi-Fi Alliance Neighbor Awareness Networking (NAN) standard specification and the second wireless communications protocol is based on an Institute of Electrical and Electronics Engineers (IEEE) 802.11 standard specification.

In some implementations, the method further includes determining to initiate a scanning operation, and responsive to determining to initiate the scanning operation, transmitting a subscribe request requesting the scanning information to the second wireless communication device over a wireless link associated with the first wireless communications protocol.

In some implementations, the scanning information further includes, for each of the identified wireless frequency channels, one or more of: a service set identifier (SSID) associated with a wireless network, a received signal strength indicator (RSSI) associated with the wireless network, one or more supported data rates of the wireless network, one or more parameters associated with the wireless network, or one or more capability requirements of the wireless network.

In some implementations, the method further includes generating or updating a scan list to include the one or more identified wireless frequency channels.

In some implementations, the method further includes discovering one or more wireless access points (APs) on the one or more scanned wireless channels, selecting a wireless AP from the discovered one or more wireless APs, and performing an association operation to associate with the selected wireless AP. In some such implementations, the method further includes generating or updating a scan list to include information associated with one or more of the discovered APs. In some such implementations, the method further includes receiving a subscribe message from a third wireless communication device over a wireless link associated with the first wireless communications protocol, and responsive to receiving the subscribe message, transmitting information in the scan list to the third wireless communication device over a wireless link associated with the first wireless communications protocol. In some such implementations, the method further includes transmitting a publish message identifying that the first wireless communications device has scanning information to provide over a wireless link associated with the first wireless communications protocol.

Another innovative aspect of the subject matter described in this disclosure can be implemented in a method for wireless communication. In some implementations, the method includes scanning, by a first wireless communication device, a plurality of wireless frequency channels in one or more frequency bands associated with one or more first wireless communications protocols. The method also includes identifying, by the first wireless communication device, a subset of the plurality of scanned wireless frequency channels on which one or more access points (APs) are operating. The method additionally includes transmitting, by the first wireless communication device, scanning information including the identified subset of wireless frequency channels to a second wireless communication device over a wireless link associated with a second wireless communications protocol.

In some implementations, the one or more first wireless communications protocols include a wireless communications protocol based on an Institute of Electrical and Electronics Engineers (IEEE) 802.11 standard specification and the second wireless communications protocol is based on a Wi-Fi Alliance Neighbor Awareness Networking (NAN) standard specification.

In some implementations, the method further includes transmitting a publish message identifying that the first wireless communications device has scanning information to provide over a wireless link associated with the second wireless communications protocol. In some implementations, the method further includes receiving a subscribe message from the second wireless communication device over a wireless link associated with the second wireless communications protocol, wherein the transmission of the scanning information is responsive to receiving the subscribe message.

In some implementations, the method further includes generating or updating a scan list to include the one or more identified wireless frequency channels.

In some implementations, the scanning information further includes, for each of the identified wireless frequency channels, one or more of: a service set identifier (SSID) associated with a wireless network, a received signal strength indicator (RSSI) associated with the wireless network, one or more supported data rates of the wireless network, one or more parameters associated with the wireless network, or one or more capability requirements of the wireless network.

Another innovative aspect of the subject matter described in this disclosure can be implemented in a wireless communication device. In some implementations, the wireless communication device includes at least one antenna, a processor, and a memory communicatively coupled with the processor and storing processor-readable code that, when executed by the processor, causes the wireless communications device to perform operations. The operations include receiving scanning information from a second wireless communication device over a wireless link associated with a first wireless communications protocol, the scanning information identifying one or more wireless frequency channels associated with a second wireless communications protocol. The operations also include selecting a subset of wireless channels associated with the second wireless communications protocol based on the scanning information. The operations additionally include scanning one or more wireless frequency channels of only the selected subset of wireless frequency channels.

In some implementations, the first wireless communications protocol is based on a Wi-Fi Alliance Neighbor Awareness Networking (NAN) standard specification and the second wireless communications protocol is based on an Institute of Electrical and Electronics Engineers (IEEE) 802.11 standard specification.

In some implementations, the code is further configured to cause the wireless communications device to determine to initiate a scanning operation, and responsive to determining to initiate the scanning operation, transmit a subscribe request requesting the scanning information to the second wireless communication device over a wireless link associated with the first wireless communications protocol.

In some implementations, the scanning information further includes, for each of the identified wireless frequency channels, one or more of: a service set identifier (SSID) associated with a wireless network, a received signal strength indicator (RSSI) associated with the wireless network, one or more supported data rates of the wireless network, one or more parameters associated with the wireless network, or one or more capability requirements of the wireless network.

In some implementations, the code is further configured to cause the wireless communications device to generate or update a scan list to include the one or more identified wireless frequency channels.

Another innovative aspect of the subject matter described in this disclosure can be implemented in a wireless communication device. In some implementations, the apparatus includes at least one antenna, a processor, and a memory communicatively coupled with the processor and storing processor-readable code that, when executed by the processor, causes the wireless communications device to perform operations. The operations include scanning a plurality of wireless frequency channels in one or more frequency bands associated with one or more first wireless communications protocols. The operations also include identifying a subset of the plurality of scanned wireless frequency channels on which one or more access points (APs) are operating. The operations additionally include transmitting scanning information including the identified subset of wireless frequency channels to a second wireless communication device over a wireless link associated with a second wireless communications protocol.

In some implementations, the one or more first wireless communications protocols include a wireless communications protocol based on an Institute of Electrical and Electronics Engineers (IEEE) 802.11 standard specification and the second wireless communications protocol is based on a Wi-Fi Alliance Neighbor Awareness Networking (NAN) standard specification.

In some implementations, the code is further configured to cause the wireless communications device to transmit a publish message identifying that the first wireless communications device has scanning information to provide over a wireless link associated with the second wireless communications protocol. In some implementations, the code is further configured to cause the wireless communications device to receive a subscribe message from the second wireless communication device over a wireless link associated with the second wireless communications protocol, wherein the transmission of the scanning information is responsive to receiving the subscribe message.

In some implementations, the code is further configured to cause the wireless communications device to generate or update a scan list to include the one or more identified wireless frequency channels.

In some implementations, the scanning information further includes, for each of the identified wireless frequency channels, one or more of: a service set identifier (SSID) associated with a wireless network, a received signal strength indicator (RSSI) associated with the wireless network, one or more supported data rates of the wireless network, one or more parameters associated with the wireless network, or one or more capability requirements of the wireless network.

Another innovative aspect of the subject matter described in this disclosure can be implemented in a tangible computer-readable storage medium comprising non-transitory processor-executable code operable to receive scanning information from a second wireless communication device over a wireless link associated with a first wireless communications protocol, the scanning information identifying one or more wireless frequency channels associated with a second wireless communications protocol. The code is also operable to select a subset of wireless channels associated with the second wireless communications protocol based on the scanning information. The code is additionally operable to scan one or more wireless frequency channels of only the selected subset of wireless frequency channels.

In some implementations, the first wireless communications protocol is based on a Wi-Fi Alliance Neighbor Awareness Networking (NAN) standard specification and the second wireless communications protocol is based on an Institute of Electrical and Electronics Engineers (IEEE) 802.11 standard specification.

In some implementations, the code is further configured to cause the wireless communications device to determine to initiate a scanning operation, and responsive to determining to initiate the scanning operation, transmit a subscribe request requesting the scanning information to the second wireless communication device over a wireless link associated with the first wireless communications protocol.

In some implementations, the code is further configured to cause the wireless communications device to generate or update a scan list to include the one or more identified wireless frequency channels.

Another innovative aspect of the subject matter described in this disclosure can be implemented in a tangible computer-readable storage medium comprising non-transitory processor-executable code operable to scan a plurality of wireless frequency channels in one or more frequency bands associated with one or more first wireless communications protocols. The code is also operable to identify a subset of the plurality of scanned wireless frequency channels on which one or more access points (APs) are operating. The code is additionally operable to transmit scanning information including the identified subset of wireless frequency channels to a second wireless communication device over a wireless link associated with a second wireless communications protocol.

In some implementations, the one or more first wireless communications protocols include a wireless communications protocol based on an Institute of Electrical and Electronics Engineers (IEEE) 802.11 standard specification and the second wireless communications protocol is based on a Wi-Fi Alliance Neighbor Awareness Networking (NAN) standard specification.

In some implementations, the code is further configured to cause the wireless communications device to transmit a publish message identifying that the first wireless communications device has scanning information to provide over a wireless link associated with the second wireless communications protocol. In some implementations, the code is further configured to cause the wireless communications device to receive a subscribe message from the second wireless communication device over a wireless link associated with the second wireless communications protocol, wherein the transmission of the scanning information is responsive to receiving the subscribe message.

In some implementations, the code is further configured to cause the wireless communications device to generate or update a scan list to include the one or more identified wireless frequency channels.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless communication system.

FIG. 2A shows an example frame usable for communications between an access point (AP) and a number of stations (STAs).

FIG. 2B shows another example frame usable for communications between an AP and a number of STAs.

FIG. 3 shows a block diagram of an example AP for use in wireless communication.

FIG. 4 shows a block diagram of an example STA for use in wireless communication.

FIG. 5 shows a block diagram of an example apparatus for use in wireless communication according to some implementations.

FIG. 6 shows a flowchart illustrating an example process for performing a targeted scan of one or more wireless frequency channels according to some implementations.

FIG. 7 shows a flowchart illustrating an example process for sharing scanning information according to some implementations.

FIG. 8 shows a flowchart illustrating an example process for associating with an AP according to some implementations.

FIG. 9 shows a timing diagram illustrating the transmissions of communications in the example process of FIG. 8.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to any of the Institute of Electrical and Electronics Engineers (IEEE) 802.11 standards, or the Bluetooth® standards. The described implementations also can be implemented in any device, system or network that is capable of transmitting and receiving RF signals according to any of the following technologies or techniques: code division multiple access (CDMA), frequency division multiple access (FDMA), orthogonal frequency division multiple access (OFDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Various implementations relate generally to the selective or targeted scanning of wireless frequency channels based on previously obtained scanning information. Some implementations more specifically relate to the sharing of scanning information associated with wireless frequency channels of one wireless communications protocol via a wireless link associated with a different wireless communications protocol. In some implementations, a wireless station (STA) receiving scanning information via a first wireless communications protocol performs a selective, targeted or limited scanning operation on a subset of wireless frequency channels associated with a second wireless communications protocol. For example, rather than performing a typical, sequential scan of all channels in each of one or more frequency bands (for example, all channels in the 2.4 GHz band and/or all channels in the 5 GHz band), the STA scans only a subset of the channels based on the shared scanning information. In some implementations, a STA may scan only those channels determined to be associated with APs expected to be within wireless range of the STA. Additionally, a STA may scan only those channels on which APs having suitable network characteristics operate. To perform such a targeted scanning operation, the STA needs information relating to the relevant channels. In various example implementations, each STA maintains a scan list including identifications of wireless frequency channels on which APs are expected to be operating. In some implementations, the scan list further includes identifications of the APs operating on the identified channels as well as other scanning information relating to the identified APs or channels.

Particular implementations of the subject matter described in this disclosure can be implemented to realize one or more of the following potential advantages. In some implementations, the described techniques can be used to reduce the power consumption associated with scanning operations as well as reduce the time spent scanning to increase the performance of the wireless device.

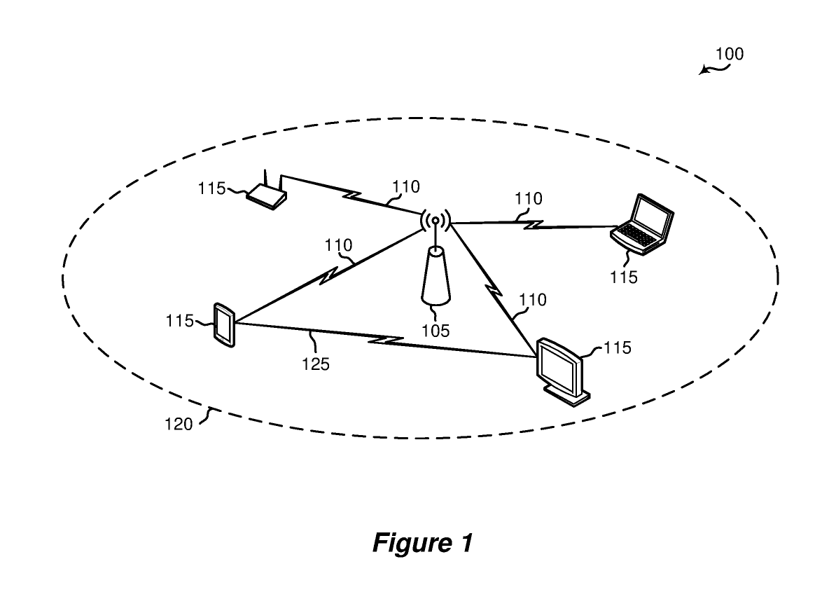

FIG. 1 shows a block diagram of an example wireless communication system 100. According to some aspects, the wireless communication system 100 can be an example of a wireless local area network (WLAN) (and will hereinafter be referred to as WLAN 100). For example, the WLAN 100 can be a network implementing at least one of the IEEE 802.11 family of standards. The WLAN 100 may include numerous wireless devices such as an access point (AP) 105 and multiple associated stations (STAs) 115. Each of the STAs 115 also may be referred to as a mobile station (MS), a mobile device, a mobile handset, a wireless handset, an access terminal (AT), a user equipment (UE), a subscriber station (SS), or a subscriber unit, among other possibilities. The STAs 115 may represent various devices such as mobile phones, personal digital assistant (PDAs), other handheld devices, netbooks, notebook computers, tablet computers, laptops, display devices (for example, TVs, computer monitors, navigation systems, among others), printers, key fobs (for example, for passive keyless entry and start (PKES) systems), among other possibilities.

Each of the STAs 115 may associate and communicate with the AP 105 via a communication link 110. The various STAs 115 in the network are able to communicate with one another through the AP 105. A single AP 105 and an associated set of STAs 115 may be referred to as a basic service set (BSS). FIG. 1 additionally shows an example coverage area 120 of the AP 105, which may represent a basic service area (BSA) of the WLAN 100. While only one AP 105 is shown, the WLAN network 100 can include multiple APs 105. An extended service set (ESS) may include a set of connected BSSs. An extended network station associated with the WLAN 100 may be connected to a wired or wireless distribution system that may allow multiple APs 105 to be connected in such an ESS. As such, a STA 115 can be covered by more than one AP 105 and can associate with different APs 105 at different times for different transmissions.

STAs 115 may function and communicate (via the respective communication links 110) according to the IEEE 802.11 family of standards and amendments including, but not limited to, 802.11a, 802.11b, 802.11g, 802.11n, 802.11ac, 802.11ad, 802.11ah, 802.11ay, 802.11ax, 802.11az, and 802.11ba. These standards define the WLAN radio and baseband protocols for the PHY and medium access control (MAC) layers. The wireless devices in the WLAN 100 may communicate over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the wireless devices described herein also may communicate in other frequency bands, such as the emerging 6 GHz band, which may support both licensed and unlicensed communications. The wireless devices in the WLAN 100 also can be configured to communicate over other frequency bands such as shared licensed frequency bands, where multiple operators may have a license to operate in the same or overlapping frequency band or bands.

In some cases, STAs 115 may form networks without APs 105 or other equipment other than the STAs 115 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 115 may be capable of communicating with each other through the AP 105 using communication links 110, STAs 115 also can communicate directly with each other via direct wireless communication links 125. Additionally, two STAs 115 may communicate via a direct communication link 125 regardless of whether both STAs 115 are associated with and served by the same AP 105. In such an ad hoc system, one or more of the STAs 115 may assume the role filled by the AP 105 in a BSS. Such a STA 115 may be referred to as a group owner (GO) and may coordinate transmissions within the ad hoc network. Examples of direct wireless communication links 125 include Wi-Fi Direct connections, connections established by using a Wi-Fi Tunneled Direct Link Setup (TDLS) link, and other peer-to-peer (P2P) group connections.

One type of P2P network is a neighbor awareness network (NAN). NANs operate in accordance with the Wi-Fi Alliance Neighbor Awareness Networking (also referred to as NAN) standard specification. NAN-compliant STAs can communicate directly with one another as opposed to communicating indirectly via an AP. A NAN device can be any device, such as a STA, that implements the NAN protocol. The NAN devices communicate within one another using a data packet routing protocol, such as Hybrid Wireless Mesh Protocol (HWMP) for path selection. In some examples, a NAN may also be implemented for data communication with other networks such as with a wired or another wireless network. A NAN concurrent device is a NAN device that is capable of operating in both a NAN network as well as another type of Wi-Fi network, such as a WLAN BSS. For example, a NAN concurrent device can provide access to a WLAN or a wireless wide-area-network (WWAN) via an access point or a base station associated with the NAN concurrent device.

NAN networks are dynamically self-organized and self-configured with NAN devices in the network automatically establishing an ad-hoc network with other NAN devices such that the network connectivity can be maintained. Each NAN device is configured to relay data for the NAN network such that various NAN devices may cooperate in the distribution of data within the network. As a result, a message can be transmitted from a source or “publisher” NAN device to a destination or “subscriber” NAN device by being propagated along a path, hopping from one NAN device to the next until the destination is reached.

A NAN network generally refers to a collection of NAN devices that share a common set of NAN parameters including: the time period between consecutive Discovery Windows, the time duration of the Discovery Windows, the beacon interval, and the NAN Discovery Channel(s). A NAN ID is an identifier signifying a specific set of NAN parameters for use within the NAN network. A NAN cluster is a collection of NAN devices within a NAN network that are synchronized to the same Discovery Window (DW) schedule. A NAN device may choose to participate in more than one NAN cluster. NAN devices within a NAN cluster are synchronized to a common clock using a time synchronization function (TSF).

A NAN DW refers to the time and channel on which NAN devices converge. During a DW, one or more NAN devices may transmit a NAN Synchronization Beacon, which is a management frame used to synchronize the timing of the NAN devices within the NAN cluster. The NAN devices may then transmit multicast or unicast NAN Service Discovery frames directly to other NAN devices within range and in the same NAN cluster during the DW. Between DWs, one or more NAN devices may transmit a NAN Discovery Beacon, which is a management frame used to facilitate discovery of NAN clusters.

There are two general NAN Service Discovery messages: a publish message and a subscribe message. Generally, publishing is a mechanism for an application on a NAN device to make selected information about the capabilities and services of the NAN device available to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a service. A NAN device may generate and transmit a publish message to make its service discoverable for other NAN devices operating within the same NAN cluster in an unsolicited manner. A NAN may also use a publish message in a solicited manner; for example, after receiving a subscribe message, a publishing NAN device capable of providing the requested service may use a publish message to reply to the subscribing NAN device responsive to the satisfaction of criteria specified in the subscribe message.

Subsequent to a DW is a transmission opportunity period. This period includes numerous resource blocks. A NAN device link (NDL) refers to the negotiated resource blocks between NAN devices used for NAN operations. There are two general NDL types: paged NDL (P-NDL) and synchronized NDL (S-NDL). Each common resource block (CRB) of a P-NDL includes a Paging Window (PW) followed by a Transmission Window (TxW). All NAN devices participating in a P-NDL operate in a state to receive frames during the PW. Generally, the participating NAN devices wake up during the PW to listen on the paging channel to determine whether there is any traffic being sent to the respective devices. If there is traffic being sent, the NAN device remains awake during the TxW to exchange the traffic. If there is no traffic being sent, the NAN device may transition back to a sleep state during the TxW to conserve power.

A NAN device transmits a paging message to its NDL peer during a PW if it has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent TxW to receive the traffic. The NDL transmitter device transmits the buffered traffic during the TxW to the recipient devices from whom it received a trigger frame.

A NAN device that establishes an S-NDL with a peer NAN device may transmit data frames to the peer from the beginning of each S-NDL CRB without transmitting a paging message in advance.

An NDL can include more than one “hop.” The number of hops depends on the number of STAs between the STA providing the service and the STA consuming or subscribing to the service. An example of an NDL that includes two hops includes three STAs: the provider STA, the subscriber STA and a proxy STA to relay the information between the provider STA and the subscriber STA. In such a configuration, the first hop refers to the communication of information between the provider STA and the proxy STA, and the second hop refers to the communication of the information between the proxy STA and the subscribing STA. An NDL may refer to a subset of NAN devices capable of one-hop service discovery, but an NDL also may be capable of service discovery and subscription over multiple hops (a multi-hop NDL).

A NAN device may join a NAN network by authenticating with one of the member NAN devices of the existing network. Upon successfully completing an authentication procedure, the NAN device may receive a group key common to the devices of the NAN network or NDL and use the common group key to discover the topology of the existing NDL by sending a route request message to the other NAN devices and receiving route reply messages from the other NAN devices. Based on the received route reply messages, the joining NAN device can determine a topology of the NDL and, accordingly, determine a route or path to a particular member NAN device, for example, such as a publisher providing a desired service.

Some types of STAs 115 may provide for automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 115 that integrate sensors or meters to measure or capture information and relay that information to a central server or application program that can make use of the information or present the information to humans interacting with the program or application.

Some of STAs 115 may be MTC devices, such as MTC devices designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications.

WLAN 100 may support beamformed transmissions. As an example, AP 105 may use multiple antennas or antenna arrays to conduct beamforming operations for directional communications with a STA 115. Beamforming (which may also be referred to as spatial filtering or directional transmission) is a signal processing technique that may be used at a transmitter (e.g., AP 105) to shape and/or steer an overall antenna beam in the direction of a target receiver (e.g., a STA 115). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 105 may communicate with the STA 115. That is, based on this CSI, the AP 105 may appropriately weight the transmissions from each antenna (e.g., or antenna port) such that the desired beamforming effects are achieved. In some cases, these weights may be determined before beamforming can be employed. For example, the transmitter (e.g., the AP 105) may transmit one or more sounding packets to the receiver in order to determine CSI.

WLAN 100 may further support multiple-input, multiple-output (MIMO) wireless systems. Such systems may use a transmission scheme between a transmitter (e.g., AP 105) and a receiver (e.g., a STA 115), where both transmitter and receiver are equipped with multiple antennas. For example, AP 105 may have an antenna array with a number of rows and columns of antenna ports that the AP 105 may use for beamforming in its communication with a STA 115. Signals may be transmitted multiple times in different directions (e.g., each transmission may be beamformed differently). The receiver (e.g., STA 115) may try multiple beams (e.g., antenna subarrays) while receiving the signals.

WLAN protocol data units (PDUs) may be transmitted over a radio frequency spectrum band, which in some examples may include multiple sub-bands or frequency channels. In some cases, the radio frequency spectrum band may have a bandwidth of 80 MHz, and each of the sub-bands or channels may have a bandwidth of 20 MHz. Transmissions to and from STAs 115 and APs 105 typically include control information within a header that is transmitted prior to data transmissions. The information provided in a header is used by a receiving device to decode the subsequent data. A legacy WLAN preamble may include legacy short training field (STF) (L-STF) information, legacy LTF (L-LTF) information, and legacy signaling (L-SIG) information. The legacy preamble may be used for packet detection, automatic gain control and channel estimation, among other uses. The legacy preamble may also be used to maintain compatibility with legacy devices.

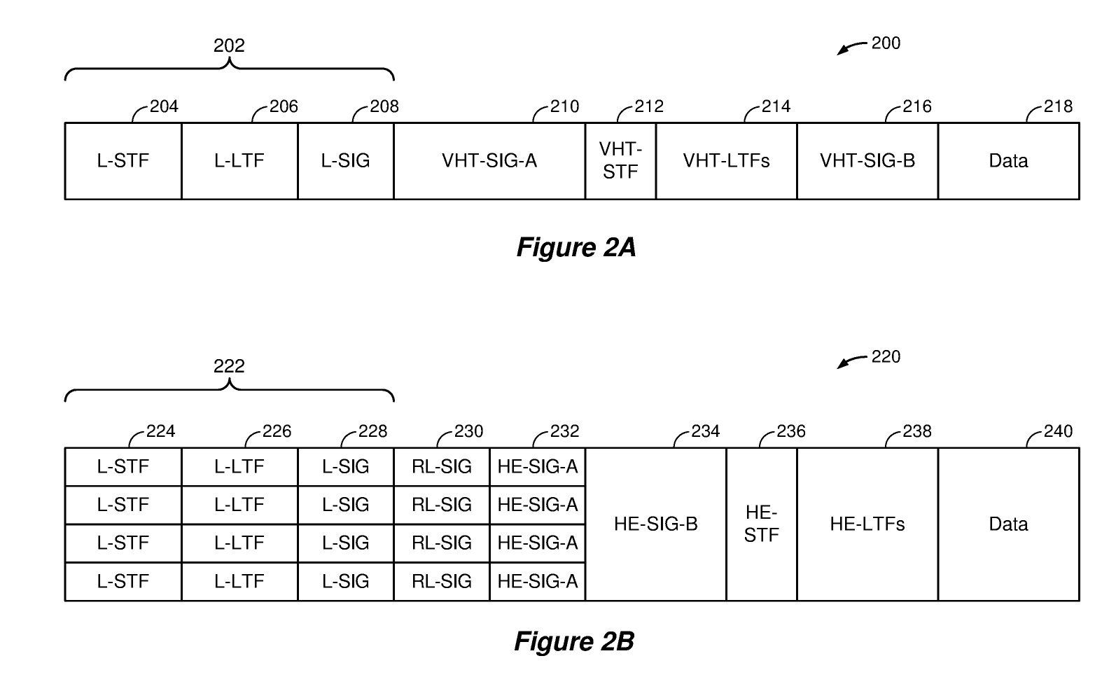

FIG. 2A shows an example frame 200 usable for communications between an AP and each of a number of stations identified by the AP. For example, the frame 200 can be formatted as a very high throughput (VHT) frame in accordance with the IEEE 802.11ac amendment to the IEEE 802.11 set of standards. The frame 200 includes a legacy preamble portion 202 that includes a legacy short training field (L-STF) 204, a legacy long training field (L-LTF) 206, and a legacy signaling field (L-SIG) 208. The frame 200 further includes a non-legacy preamble portion that includes a first very high throughput (VHT) signaling field (VHT-SIG-A) 210, a VHT short training field (VHT-STF) 212, a number of VHT long training fields (VHT-LTFs) 214 and a second VHT signaling field (VHT-SIG-B) 216. The frame 200 also can include a payload or data portion 218 after the preamble. The data portion 218 can include medium access control (MAC) protocol data units (MPDUs), for example, in the form of an aggregated MPDU (AMPDU).

The frame 200 may be transmitted over a radio frequency spectrum band, which may include a plurality of sub-bands. For example, the radio frequency spectrum band may have a bandwidth of 80 MHz, and each of the sub-bands may have a bandwidth of 20 MHz. When the radio frequency spectrum band includes a plurality of sub-bands, the L-STF, L-LTF, and L-SIG fields 204, 206 and 208, respectively, may be duplicated and transmitted in each of the plurality of sub-bands. The information in the VHT-SIG-A field 210 is also duplicated and transmitted in each sub-band.

The VHT-SIG-A field 210 may indicate to a station that the frame 200 is an IEEE 802.11ac frame. The VHT-SIG-A field 210 also may include VHT WLAN signaling information usable by stations other than the number of stations that are identified to receive downlink communications in the frame 200. The VHT-SIG-A field 210 also includes information usable by the identified number of stations to decode the VHT-SIG-B field 216. The VHT-SIG-B field 216 may include VHT WLAN signaling information usable by the number of stations identified to receive downlink communications in the frame 200. More specifically, the VHT-SIG-B field 216 may include information usable by the number of stations to decode data received in the data portion 218. The VHT-SIG-B field 216 may be encoded separately from the VHT-SIG-A field 210. The number of VHT-LTFs 214 depends on the number of transmitted streams.

FIG. 2B shows another example frame 220 usable for communications between an AP and each of a number of stations identified by the AP. For example, the frame 220 can be formatted as a high efficiency (HE) frame in accordance with the IEEE 802.11ax amendment to the IEEE 802.11 set of standards. The frame 220 includes a legacy preamble portion 222 that includes a legacy short training field (L-STF) 224, a legacy long training field (L-LTF) 226, and a legacy signaling field (L-SIG) 228. The frame 220 further includes a non-legacy preamble portion that includes a repeated legacy signaling field (RL-SIG) 230, a first high efficiency signaling field (HE-SIG-A) 232, a second high efficiency signaling field (HE-SIG-B) 234, a high efficiency short training field (HE-STF) 236 and a number of high efficiency long training fields (HE-LTFs) 238. The frame 220 also can include a payload or data portion 240 after the preamble. The data portion 240 can include medium access control (MAC) protocol data units (MPDUs), for example, in the form of an aggregated MPDU (AMPDU).

The frame 220 may be transmitted over a radio frequency spectrum band, which may include a plurality of sub-bands. For example, the radio frequency spectrum band may have a bandwidth of 80 MHz, and each of the sub-bands may have a bandwidth of 20 MHz. When the radio frequency spectrum band includes a plurality of sub-bands, the L-STF, L-LTF, and L-SIG fields 224, 226 and 228, respectively, may be duplicated and transmitted in each of the plurality of sub-bands. The information in the RL-SIG field 230 and the HE-SIG-A field 232 is also duplicated and transmitted in each sub-band as shown in FIG. 2B.

The RL-SIG field 230 may indicate to a station that the frame 220 is an IEEE 802.11ax frame. The HE-SIG-A field 232 may include high efficiency WLAN signaling information usable by stations other than the number of stations that are identified to receive downlink communications in the frame 220. The HE-SIG-A field 232 may also include information usable by the identified number of stations to decode the HE-SIG-B field 234. The HE-SIG-B field 234 may include high efficiency WLAN signaling information usable by the number of stations identified to receive downlink communications in the frame 220. More specifically, the HE-SIG-B field 234 may include information usable by the number of stations to decode data received in the data portion 240. The HE-SIG-B field 234 may be encoded separately from the HE-SIG-A field 232.

High efficiency (HE) WLAN (HEW) preambles can be used to schedule multiple devices, such as STAs 115, for multi-user simultaneous transmissions (for example, using multi-user orthogonal frequency division multiple access (MU-OFDMA) or multi-user multiple-input, multiple-output (MU-MIMO) techniques). A HEW signaling field may be used to signal a resource allocation pattern to multiple receiving STAs 115. The HEW signaling field can include a common user field that is decodable by multiple STAs 115, as well as a resource allocation field. The resource allocation field can indicate resource unit distributions to multiple STAs 115 and indicate which resource units in a resource unit distribution correspond to MU-MIMO transmissions and which resource units correspond to OFDMA transmissions. The HEW signaling field also can include, subsequent to the common user field, dedicated station-specific signaling fields that are assigned to particular STAs 115 and used to schedule resources and to indicate the scheduling to other WLAN devices.

In some cases, aspects of transmissions may vary based on a distance between a transmitter (for example, AP 105) and a receiver (for example, STA 115). WLAN 100 may otherwise generally benefit from AP 105 having information regarding the location of the various STAs 115 within coverage area 120. In some examples, relevant distances may be computed using RTT-based ranging procedures. As an example, WLAN 100 may offer such functionality that produces accuracy on the order of one meter (or even centimeter-level accuracy). The same (or similar) techniques employed in WLAN 100 may be applied across other wireless communications protocols. For example, such RTT-based ranging functionality may be employed in developing “relative geofencing” applications (i.e., applications where there is a geofence relative to an object of interest such as a mobile device, a car, a person, etc.). Various such examples are considered in accordance with aspects of the present disclosure. For example, car keys may employ RTT estimation for PKES systems. RTT-based geofences around an adult may monitor the position of a child within the geofence. Additionally, drone-to-drone and car-to-car RTT functionality may help prevent collisions.

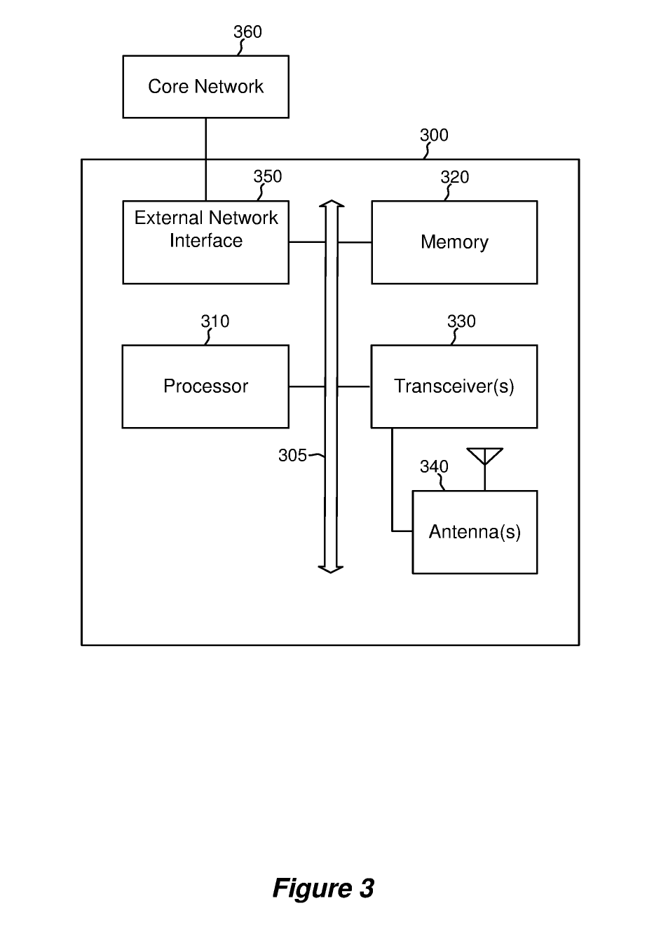

FIG. 3 shows a block diagram of an example access point (AP) 300 for use in wireless communication. For example, the AP 300 may be an example of aspects of the AP 105 described with reference to FIG. 1. The AP 400 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The AP 300 includes a processor 310, a memory 320, at least one transceiver 330, at least one antenna 340, and an external network interface 350 (for example, to connect with a backhaul). Each of the components (or “modules”) described with reference to FIG. 3 can communicate with one another, directly or indirectly, over at least one bus 305.

The memory 320 can include random access memory (RAM) and read-only memory (ROM). The memory 320 also can store processor- or computer-executable software (SW) code 325 containing instructions that, when executed by the processor 310, cause the processor to perform various functions described herein for wireless communication, including generation and transmission of a downlink frame and reception of an uplink frame.

The processor 310 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 310 processes information received through the transceiver 330, the AP communications module 360, and the network communications module 370. The processor 310 also can process information to be sent to the transceiver 330 for transmission through the antenna 340, information to be sent to the AP communications module 360, and information to be sent to the network communications module 370. The processor 310 can generally be configured to perform various operations related to generating and transmitting a downlink frame and receiving an uplink frame.

The transceiver 330 can include a modem to modulate packets and provide the modulated packets to the antenna 340 for transmission, as well as to demodulate packets received from the antenna 340. The transceiver 330 can be implemented as at least one radio frequency (RF) transmitter and at least one separate RF receiver. The transceiver 330 can communicate bi-directionally, via the antenna 340, with at least one station 115 as, for example, shown in FIG. 1. Although only one transceiver 330 and one antenna 340 are shown in FIG. 3, the AP 300 can typically include multiple transceivers 330 and antennas 340. For example, in some AP implementations, the AP 300 can include multiple transmit antennas (each with a corresponding transmit chain) and multiple receive antennas (each with a corresponding receive chain). The AP 300 may communicate with a core network 360 through the external network interface 350 to gain access to external networks including the Internet.

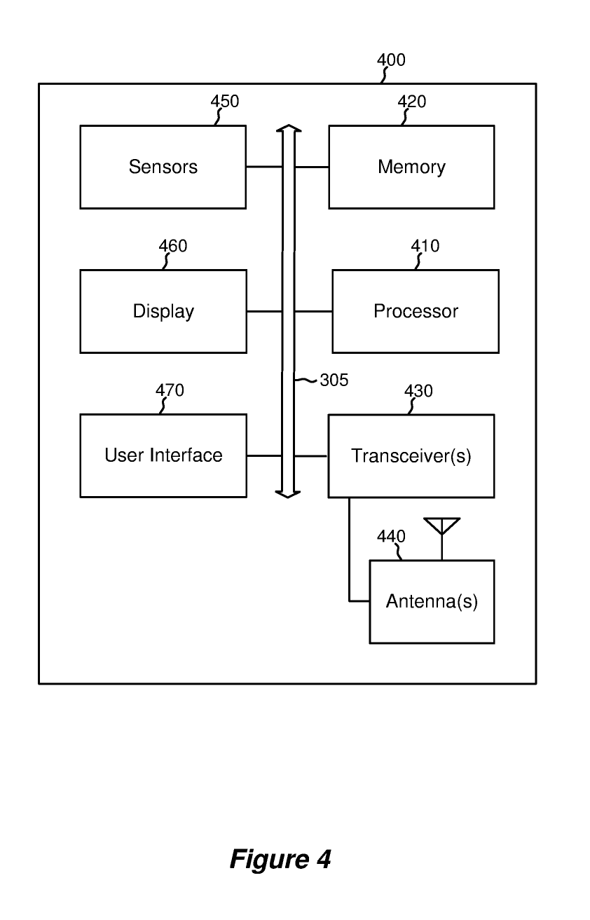

FIG. 4 shows a block diagram of an example wireless station (STA) 400 for use in wireless communication. For example, the STA 400 may be an example of aspects of the STA 115 described with reference to FIG. 1. The STA 400 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The STA 400 includes a processor 410, a memory 420, at least one transceiver 430 and at least one antenna 440. In some implementations, the STA 400 additionally includes one or more of sensors 450, a display 460 and a user interface (UI) 470 (such as a touchscreen or keypad). Each of the components (or “modules”) described with reference to FIG. 4 can communicate with one another, directly or indirectly, over at least one bus 405.

The memory 420 can include RAM and ROM. The memory 420 also can store processor- or computer-executable SW code 425 containing instructions that, when executed, cause the processor 410 to perform various functions described herein for wireless communication, including reception of a downlink frame and generation and transmission of an uplink frame.

The processor 410 includes an intelligent hardware device such as, for example, a CPU, a microcontroller, an ASIC or a PLD such as an FPGA, among other possibilities. The processor 410 processes information received through the transceiver 430 as well as information to be sent to the transceiver 430 for transmission through the antenna 440. The processor 410 can be configured to perform various operations related to receiving a downlink frame and generating and transmitting an uplink frame.

The transceiver 430 can include a modem to modulate packets and provide the modulated packets to the antenna 440 for transmission, as well as to demodulate packets received from the antenna 440. The transceiver 430 can be implemented as at least one RF transmitter and at least one separate RF receiver. The transceiver 430 can communicate bi-directionally, via the antenna 440, with at least one AP 115 as, for example, shown in FIG. 1. Although only one transceiver 430 and one antenna 440 are shown in FIG. 4, the STA 400 can include two or more antennas. For example, in some STA implementations, the STA 400 can include multiple transmit antennas (each with a corresponding transmit chain) and multiple receive antennas (each with a corresponding receive chain).

As described above, a wireless local area network (such as WLAN 100) may be formed by one or more access points (such as AP 105) that provide a shared wireless communication medium for use by a number of client devices also referred to as stations (such as STAs 115). The basic building block of a WLAN conforming to the IEEE 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or maintain a communication link with the WLAN. In a typical WLAN, each STA may be associated with only one AP at a time. As a result of the increasing ubiquity of wireless networks, a STA may have an opportunity to select one of many WLANs within range of the STA and/or select among multiple APs that together form an extended BSS. After association with an AP, a STA also may be configured to periodically scan its surroundings to find a more suitable AP with which to associate. For example, a STA that is moving relative to its associated AP may perform a “roaming” scan to find an AP having more desirable network characteristics such as a greater received signal strength indicator (RSSI). This may occur when a STA is moving out of the coverage area of one AP and into the coverage area of another AP.

To identify an AP with which to associate, a STA is configured to perform scans on the wireless channels of each of one or more frequency bands (for example, the 2.4 GHz band, the 5 GHz band, the 6 GHz band and/or the 60 GHz band). Scans may be passive or active. A STA may perform a passive scan on a given channel by spending a duration of time on the channel so that it can receive any beacons that are periodically broadcast by APs within range and operating on that channel. A STA may alternatively perform an active scan on a given channel by transmitting a probe request to trigger probe responses from APs within range and operating on that channel. A STA may spend a considerable length of time to complete a comprehensive scan of the available wireless channels. Because scanning operations may consume a significant amount of power, it is desirable to reduce power consumption associated with scanning operations. Additionally, because scanning operations may consume a significant amount of time, it is desirable to reduce the amount of time spent scanning to increase the performance of the wireless device.

Various implementations relate generally to the selective or targeted scanning of wireless frequency channels based on previously obtained scanning information. Some implementations more specifically relate to the sharing of scanning information associated with wireless frequency channels of one wireless communications protocol via a wireless link associated with a different wireless communications protocol. In some implementations, a wireless station (STA) receiving scanning information via a first wireless communications protocol performs a selective, targeted or limited scanning operation on a subset of wireless frequency channels associated with a second wireless communications protocol. For example, rather than performing a typical, sequential scan of all channels in each of one or more frequency bands (for example, all channels in the 2.4 GHz band and/or all channels in the 5 GHz band), the STA scans only a subset of the channels based on the shared scanning information. In some implementations, a STA may scan only those channels determined to be associated with APs expected to be within wireless range of the STA. Additionally, a STA may scan only those channels on which APs having desirable network characteristics operate.

To perform such a targeted scanning operation, the STA needs information relating to the relevant channels. In various example implementations, each STA maintains a scan list including identifications of wireless frequency channels on which APs are expected to be operating. In some implementations, the scan list further includes identifications of the APs operating on the identified channels as well as other scanning information relating to the identified APs or channels. In the present context, scanning information may refer to any information that may be obtained in an active or passive scan as well as other information derived from or otherwise determined based on such information. For example, in addition to the SSIDs of any active WLANs, the scanning information also can include RSSIs, supported data rates, parameter sets and capability requirements associated with the respective APs. The scanning information also may include one or more metrics associated with the obtained information.

In some example implementations, scanning information already obtained by one or more other wireless communication devices (for example, other STAs) may be shared with the requesting STA via a NAN wireless communication link such as an NDL. In some example implementations, a NAN-enabled STA may both publish information associated with various wireless frequency channels and APs as well as subscribe to information associated with various wireless frequency channels and APs over a NAN network. For example, a NAN-enabled STA may publish scanning information it has obtained itself through active or passive scanning. In some implementations, the NAN-enabled STA may additionally or alternatively publish scanning information it has obtained from other NAN-enabled STAs, for example, other NAN-enabled STAs within one hop.

In some implementations, the described techniques can reduce the power consumption associated with scanning operations by reducing the number of channels that a STA scans. Additionally, by reducing the number of channels to scan, the amount of time spent performing a scanning operation also is reduced potentially resulting in an increase in the performance of the STA.

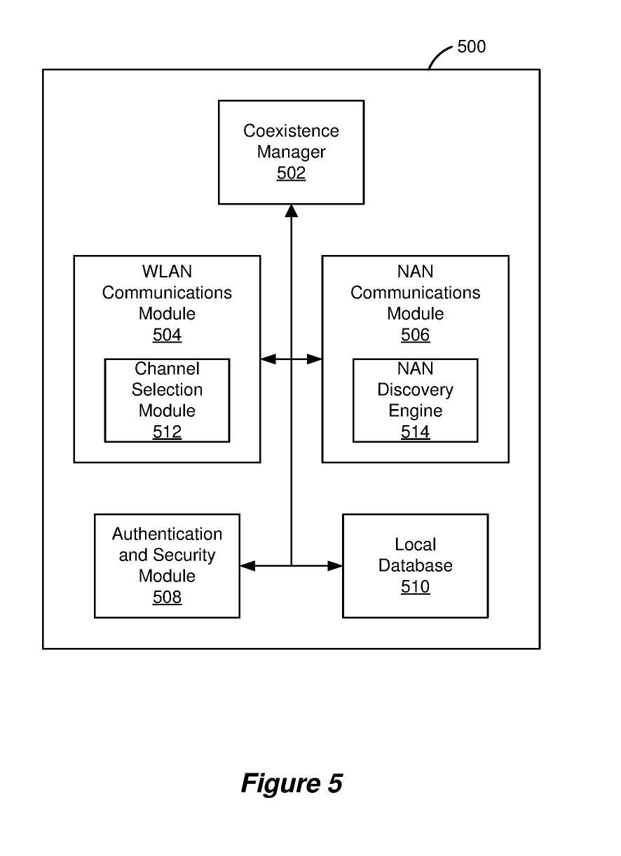

FIG. 5 shows a block diagram of an example apparatus 500 for use in wireless communication according to some implementations. In some implementations, the apparatus 500 can be an example of the STAs 115 and 400 described above with reference to FIGS. 1 and 4, respectively. The apparatus 500 includes a coexistence manager module (“coexistence manager”) 502, a WLAN communications module 504, a NAN communications module 506, an authentication and security module 508 and a local database 510. In some implementations, the WLAN communications module 504 further includes a channel selection module 512 and the NAN communications module 506 further includes a NAN discovery engine 514.

In some implementations, each of the modules 502, 504, 506 and 508 (including the channel selection module 512 and NAN discovery engine 514) are implemented as software stored in a memory (such as the memory 420). For example, each of the modules 502, 504, 506 and 508 can be implemented as non-transitory instructions (or “code”) executable by a processor (such as the processor 410). In some implementations, the processor 410 can execute the WLAN communications module 504 to manage communications based on an Institute of Electrical and Electronics Engineers (IEEE) 802.11 standard specification such as the 802.11-2016 standard as well as current and future amendments thereof, including 802.11ax.

In some implementations, the WLAN communications module 504 may manage communications associated with an infrastructure BSS and associated AP. The processor 410 can execute the WLAN communication module 504 to manage wireless communications with an AP that can provide access to an external network and to other STAs. For example, the WLAN communication module 504 is configured to generate, exchange and process frames (such as data frames, control frames, management frames, and trigger frames) to be transmitted to, or received from, an AP via one or more transceivers (such as transceiver 430). The WLAN communication module 504 also is configured to perform, via the channel selection module 512, passive or active scan operations on one or more frequency bands (for example, the 2.4 GHz, 5 GHz, 6 GHz or 60 GHz bands), for example, by listening for beacons or by generating probe requests and receiving probe responses via a transceiver. In various implementations, the WLAN communication module 504 is capable of performing a targeted or selective scan operation, for example, scanning only those wireless frequency channels on which APs are expected to operate. The WLAN communication module 504 is further configured to, via the channel selection module 512, identify or select an AP with which to associate based on scanning information obtained through a passive or active scan. The WLAN communication module 504 also is configured to manage association (in conjunction with the authentication and security module 508) with the selected AP.

The channel selection module 512 is configured to store scanning information it has itself obtained through passive or active scans. In various implementations, the channel selection module 512 is further configured to store scanning information it has obtained from one or more other NAN devices, such as other STAs, via NAN communications as described herein. In some implementations, the channel selection module 512 is configured to store, in the local database 510, scanning information including a number of wireless frequency channels on each of which one or more APs may be operating. In some implementations, the scanning information also includes an identifier of each of the APs identified as operating on the identified frequency channels. In some implementations, the scanning information includes, for each identified AP, an identifier of a primary wireless frequency channel on which the AP is currently operating or previously operated. In some implementations, the scanning information includes, for each identified AP, one or more of a respective SSID, a respective MAC address or a respective IP address. In some implementations, the scanning information may additionally include, for one or more of the identified APs, a number of capabilities or capability requirements of the AP, supported data rates of the AP, one or more parameters associated with the respective wireless network, a connection history with the AP, a geographic location of the AP, channel state information (CSI), RSSI values, or any other suitable information. In some implementations, the scanning information further includes one or more of: a timestamp or timing metric indicating a time when a particular element of scanning information was obtained, a distance metric indicating a location of an AP associated with a one of the wireless networks, or a quality metric indicating a measure of performance associated with a particular one of the wireless networks.

In various implementations, the channel selection module 512 is further configured to generate, update or otherwise maintain a scan list based on the scanning information it has itself obtained through passive or active scanning operations, as well as scanning information received from other wireless devices, such as other NAN-compliant STAs via NAN communications. In some implementations, the scan list includes a subset of the available frequency channels in one or more frequency bands of interest (such as one or more of the 2.4 GHz, 5 GHz, 6 GHz or 60 GHz bands). For example, the scan list can include identifiers of only those frequency channels in one or more frequency bands of interest on which APs are expected to operate based on the scanning information. In some implementations, the scan list can more specifically include identifiers of only those frequency channels in one or more frequency bands of interest on which APs having suitable or desirable network characteristics are expected to operate based on the scanning information. In some implementations, the scan list also includes one or more identifiers of any APs or respective WLANs operating on a given channel in the scan list.

As described above, the channel selection module 512 is configured to generate, update or otherwise maintain the scan list based on scanning information. As is also described above, the channel selection module 512 can obtain scanning information by performing one or more passive or active scans in one or more frequency bands of interest. For example, the channel selection module 512 can obtain scanning information for particular frequency channels from beacons or probe responses received on the respective channels. But, advantageously, the channel selection module 512 also can receive such scanning information from one or more other wireless devices, such as other NAN-compliant STAs, through NAN based communications such as the publish and subscribe mechanisms described herein.

In some implementations, NAN-compliant devices share scanning information by sharing their respective scan lists. In some such implementations, a wireless device such as the apparatus 500 may be configured to share with other devices only the wireless frequency channels for which it has determined that APs may be operating, and in some such implementations, also identifiers of the associated APs operating on the respective channels. In some implementations, the channel selection module 512 can be configured to automatically integrate or merge a scan list obtained from a peer device into its own scan list. In some other implementations, the channel selection module 512 can be configured to integrate only those channels from the obtained scan list that are determined to be relevant.

The relevance of any particular channel can be based on other scanning information or on various associated metrics. For example, in some implementations, a scan list generated, maintained or received by the channel selection module 512 also can include other scanning information including identifiers of one or more network parameters or characteristics associated with the identified frequency channels. The network parameters or characteristics can include, for example, any characteristics obtainable from a passive scan or an active scan, or any characteristics derived therefrom, such as one or more of a capability of the identified AP, supported data rates of the AP, CSI, RSSI values, or any other suitable information. In some implementations, each element of scanning information included in a scan list obtained from a peer device (again, such as a NAN-compliant STA such as the apparatus 500) can be associated with a timestamp indicating a time when the particular element of scanning information was obtained by the peer device. Such timestamps may be used by the channel selection module 512 to generate or track a timing metric usable to weight or otherwise adjust the relevance of the associated frequency channel. In some implementations, the channel selection module 512 also can generate or track a distance metric indicating a location of an AP associated with an identified frequency channel, or a quality metric indicating a measure of performance associated with a particular frequency channel.

Generally, the channel selection module 512 can update its scan list to include an additional frequency channel when scanning information indicates that an AP was found to be operating on the respective channel. In some implementations, the channel selection module 512 can more specifically update the scan list to include an additional frequency channel when scanning information indicates that an AP having suitable network characteristics was found to be operating on the respective channel. In some implementations, the channel selection module 512 can more particularly update the scan list to include an additional frequency channel when scanning information indicates that an AP having suitable network characteristics was found to be operating on the respective channel within a threshold time duration after the associated scanning information was obtained. Similarly, the channel selection module 512 may be configured to update the scan list to remove an existing frequency channel when scanning information indicates that an AP was not found to be operating on the respective channel, or when scanning information indicates that an AP having suitable network characteristics was not found to be operating on the respective channel, or when scanning information indicates that an AP having suitable network characteristics was not found to be operating on the respective channel within a threshold time duration after the associated scanning information was obtained.

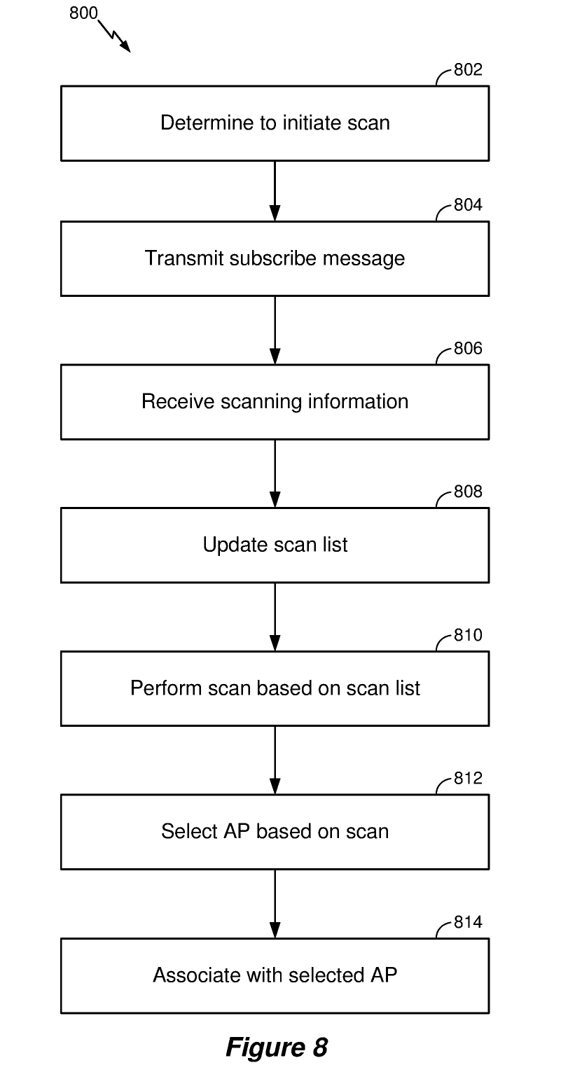

The processor 410 can execute the NAN communications module 506 to manage communications based on a Wi-Fi Alliance Neighbor Awareness Networking (NAN) standard specification. In some implementations, the NAN communications module 506 may manage communications with other NAN devices (such as other examples of the apparatus 500) of a NAN network or a NAN cluster. Such other NAN devices may include a number of NAN-compliant STAs, some of which may be NAN concurrent devices, that may provide various services to other devices of the NAN network. For example, the NAN communication module 506 is configured to generate, exchange and process frames (such as data frames, control frames, management frames, trigger frames or any of the NAN frames described herein with reference to FIG. 8 or elsewhere) to be transmitted to, or received from, other NAN devices via one or more transceivers (such as transceiver 430).

The processor 410 can execute the NAN Discovery Engine 514 to implement the publish and subscribe mechanisms described herein. For example, the discovery engine 514 may generate an instance of a publish function. Each instance of the publish function may have an identifier that uniquely identifies the instance locally. Each instance of the publish function generates a publish message to be transmitted by a transmitter of the NAN device to make a service discoverable with given parameters to other NAN devices. For example, and in accordance with various implementations, the service published by a NAN device may be a scan list as described herein.

The discovery engine 514 may generate an instance of a subscribe function. Each instance of the subscribe function may have an identifier that uniquely identifies the instance locally. Each instance of the subscribe function may generate a subscribe message to be transmitted by the transmitter to search for a service with given parameters from other NAN devices.

When an instance of the publish function receives a subscribe message, the publish function instance determines whether the subscribe message meets the trigger conditions. A discovery result event is transmitted for each published service that is found on any remote NAN device that matches the conditions specified in a previously transmitted subscribe message. A reply is sent when an instance of a publish function is active and the conditions specified in the subscribe message are met. For example, if the conditions are met, the publish function triggers the generation and transmission of a publish message to the subscribing device. The discovery engine also may transmit a follow-up message with content directed to the subscribing device and also directed to the particular instance of the subscribe function that generated the subscribe message.

The processor 410 can execute the coexistence manager 502 to manage coexistence, for example, when both the WLAN communications module 504 as well as the NAN communications module 506 are operating. The coexistence manager 502 can be configured to temporally separate the transmissions from the WLAN communications module 504 and the NAN communications module 506 so as to avoid interference.

The processor 410 can execute the authentication and security module 508 to manage authentication with the selected AP and to enable secure communication of data to and from the AP after association.

The local database 510 may be stored with each of the modules 502, 504, 506 and 508 in a memory (such as the memory 420). In some other implementations, the local database 510 is stored in or implemented by another memory or memory device logically or physically separate from the memory used to store each of the modules 502, 504, 506 and 508. In various implementations, the local database 510 stores profile information for various other wireless communications devices. The local database 510 can store profile information for each AP the apparatus 500 is or has been associated with, as well as profile information for one or more APs it has not previously associated with. For example, the profile information may include any of the scanning information obtained by the channel selection module 512 through passive or active scans as well as through NAN communications received from peer devices. As described above, the scanning information can include, for each identified AP, a respective SSID, a respective MAC address, a respective IP address, a number of capabilities or capability requirements, supported data rates, one or more parameters associated with the respective wireless network, a connection history with the AP, a geographic location of the AP, channel state information (CSI), RSSI values, primary and secondary frequency channels on which the AP is currently operating or previously operated, other scanning information, or any other suitable information. In various implementations, the local database also stores a scan list, for example, constructed or generated by the channel selection module 512 based on the scanning information.

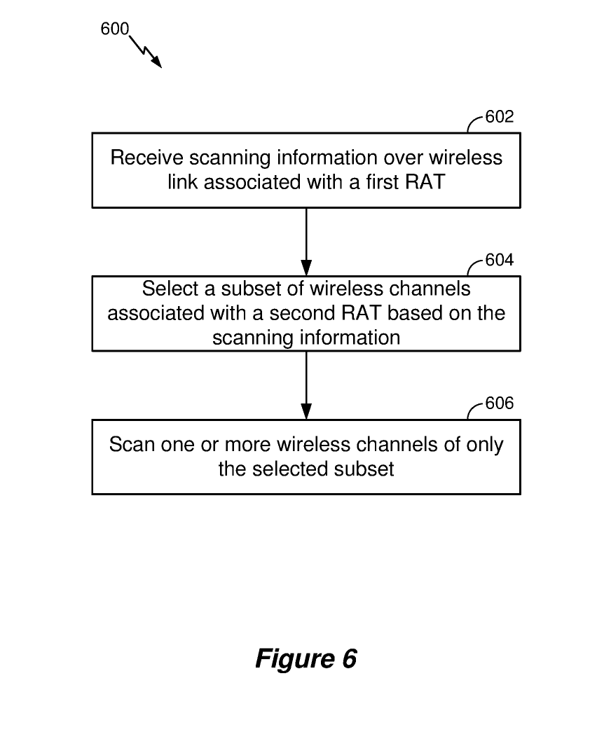

FIG. 6 shows a flowchart illustrating an example process 600 for performing a targeted scan of one or more wireless frequency channels according to some implementations. In some implementations, the targeted scan of the wireless frequency channels is performed in one or more of the 2.4 GHz band, the 5 GHz band, the 6 GHz band or the 60 GHz band. In some implementations, the process 600 is performed by a NAN concurrent STA such as the wireless communications device 500 described with reference to FIG. 5 (and will hereinafter be described with reference to the wireless communications device 500).

In some implementations, the process 600 begins in block 602 with receiving scanning information from a second wireless communication device (such as another STA) over a wireless link associated with a first wireless communications protocol. For example, the first wireless communications protocol can be based on a Wi-Fi Alliance Neighbor Awareness Networking (NAN) standard specification, and the wireless link can be an NDL. The scanning information includes information associated with one or more wireless frequency channels associated with a second wireless communications protocol. For example, the second wireless communications protocol can be based on an Institute of Electrical and Electronics Engineers (IEEE) 802.11 standard specification, such as 802.11-2016 or any amendment thereof including one or more of 802.11ad, 802.11ay, 802.11ax and 802.11ba. The scanning information can include, for example, information associated with one or more frequency channels and associated APs of respective WLANs, and specifically infrastructure BSSs.

In some implementations, the received scanning information includes information associated with each of one or more wireless frequency channels the second communication device has identified based on its own scans as channels on which APs are expected to be operating. In various implementations, the received scanning information specifically includes a scan list that includes a primary frequency channel on which each of the one or more APs within wireless range of the second communication device is currently operating or has previously operated within a threshold duration of time. In some implementations, the receiving scanning information may also include information associated with each of one or more wireless frequency channels the second communication device has identified based on scanning information it has received from a third communication device.

In some implementations, the scanning information may further include, for each identified primary frequency channel, information identifying or otherwise associated with one or more APs operating on the identified channel. For example, a scan list identifying the wireless frequency channels on which APs are expected to be operating may include, for each identified AP, a respective SSID, a respective MAC address, a respective IP address, a number of capabilities or capability requirements, supported data rates, one or more parameters associated with the respective WLAN, a geographic location of the AP, RSSI values or any other suitable information.

In various implementations, the process 600 proceeds in block 604 with selecting a subset of a set of wireless frequency channels associated with the second wireless communications protocol based on the scanning information. The set of wireless frequency channels from which the subset is selected can include the set of permitted frequency channels in one or more frequency bands (such as, for example, one or more of the 2.4 GHz, 5 GHz, 6 GHz or 60 GHz bands). Each of the selected subset of wireless frequency channels is a channel on which one or more APs are expected to be operating based on the scanning information. For example, in implementations in which the scanning information received in block 602 includes a scan list, the selected subset of wireless frequency channels can include the channels identified in the scan list. The selected subset of wireless frequency channels also can include wireless frequency channels the apparatus has itself previously determined to be channels on which one or more APs may be operating.

The process 600 then proceeds in block 606 with scanning one or more wireless channels of only the selected subset of wireless channels. The apparatus 500 may then select an AP operating on one of the scanned channels based on the information obtained in the scan in block 606. The apparatus 500 may then initiate an association operation with the selected AP.

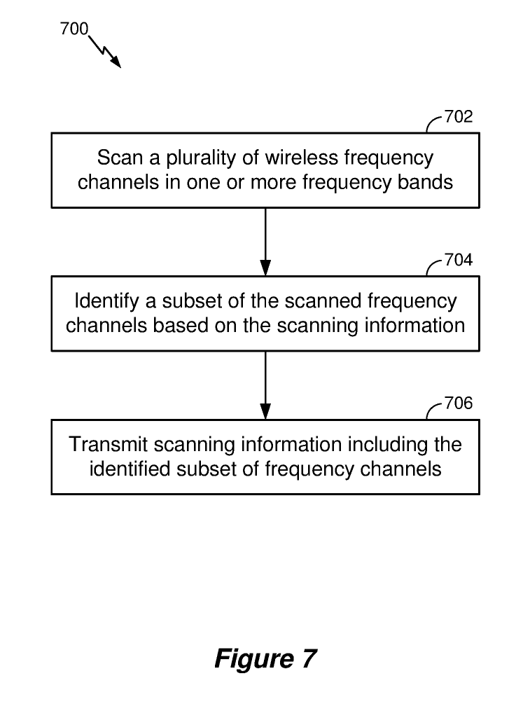

FIG. 7 shows a flowchart illustrating an example process 700 for sharing scanning information according to some implementations. In some implementations, the scanning information is associated with wireless frequency channels in one or more of the 2.4 GHz band, the 5 GHz band, the 6 GHz band or the 60 GHz band. In some implementations, the process 700 is performed by a NAN concurrent STA such as the wireless communications device 500 described with reference to FIG. 5 (and will hereinafter be described with reference to the wireless communications device 500).

In some implementations, the process 700 begins in block 702 with scanning a plurality of wireless frequency channels in one or more frequency bands associated with one or more first wireless communications protocols (such as, for example, one or more of the 2.4 GHz, 5 GHz, 6 GHz or 60 GHz bands). For example, the first wireless communications protocols can be based on an Institute of Electrical and Electronics Engineers (IEEE) 802.11 standard specification, such as 802.11-2016 or any amendment thereof including one or more of 802.11ad, 802.11ay, 802.11ax and 802.11ba. The apparatus 500 may obtain scanning information associated with one or more of the scanned wireless frequency channels.

The scanning information includes information associated with each of the plurality of scanned wireless frequency channels. In various implementations, the scanning information specifically includes wireless frequency channels on which each of the one or more APs within wireless range of the second communication device is currently operating, for example, as determined from one or more received beacons or probe responses. In some implementations, the scanning information may further include, for each identified primary frequency channel, information identifying or otherwise associated with one or more APs operating on the identified channel. For example, the scanning information may include, for each AP, a respective SSID, a respective MAC address, a respective IP address, a number of capabilities or capability requirements, supported data rates, one or more parameters associated with the respective WLAN, a geographic location of the AP, RSSI values or any other suitable information.

The process 700 proceeds in block 704 with identifying a subset of the plurality of scanned wireless frequency channels on which one or more access points (APs) are operating based on the collected scanning information obtained in block 702. In some implementations, identifying the subset of wireless frequency channels in block 704 includes generating or updating a scan list to include the one or more identified wireless frequency channels on which one or more APs are respectively operating.

In some implementations, the apparatus 500 subsequently transmits, in block 706, scanning information including the identified subset of wireless frequency channels to a second wireless communication device (such as a second NAN concurrent STA such as the apparatus 500) over a wireless link associated with a second wireless communications protocol. For example, the second wireless communications protocol can be based on a Wi-Fi Alliance Neighbor Awareness Networking (NAN) standard specification, and the wireless link can be an NDL. In some implementations, the scanning information transmitted in block 706 includes a scan list, for example, as may have been previous generated or updated in block 704.

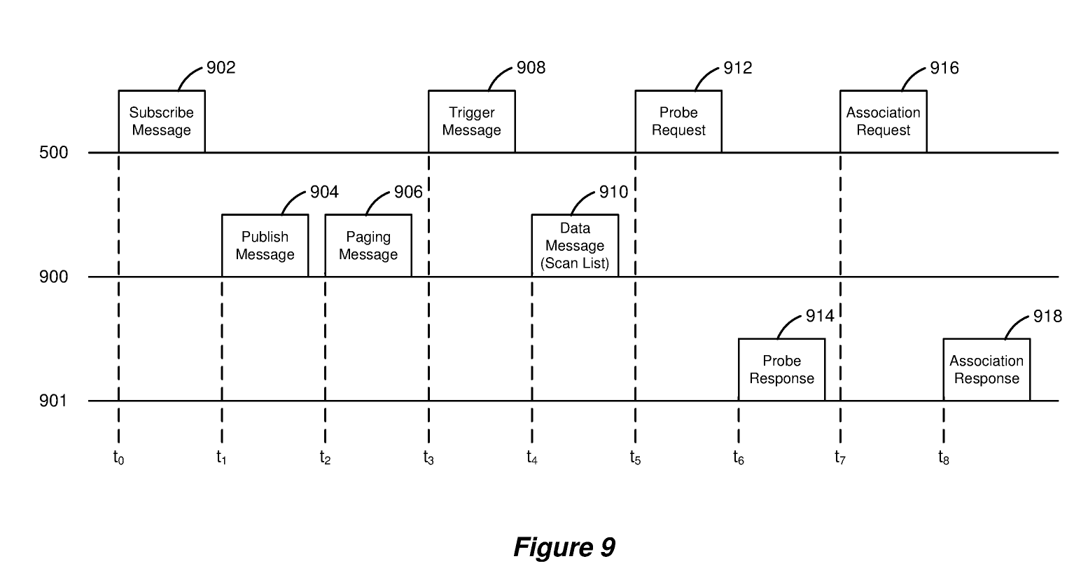

FIG. 8 shows a flowchart illustrating an example process 800 for associating with an AP according to some implementations. FIG. 9 shows a timing diagram 900 illustrating the transmissions of communications in the example process 800 of FIG. 8. In some implementations, the process 800 is performed by a NAN concurrent STA such as the wireless communications device 500 described with reference to FIG. 5 (and will hereinafter be described with reference to the wireless communications device 500).

The process 800 begins in block 802 with determining to initiate a scanning operation associated with an Institute of Electrical and Electronics Engineers (IEEE) 802.11 standard specification, such as 802.11-2016 or any amendment thereof including one or more of 802.11ad, 802.11ay, 802.11ax and 802.11ba. The scanning information can include, for example, information associated with one or more frequency channels and associated APs of respective WLANs, and specifically infrastructure BSSs.

Responsive to determining to initiate the scanning operation, the process proceeds in block 804 with transmitting a subscribe message requesting scanning information to at least one second wireless communication device. FIG. 9 shows the subscribe message 902 transmitted at time t₀ by the apparatus 500. In some implementations, the subscribe message 902 as well as the messages described below with reference to elements 904, 906, 908 and 910, are transmitted over a wireless link associated with a Wi-Fi Alliance Neighbor Awareness Networking (NAN) standard specification, for example, an NDL. In some example implementations, block 804 includes initiating a subscribe function that generates the subscribe message 902. In some implementations, the requested scanning information is or includes a scan list as described above.

In response to receiving the subscribe message 902, any neighboring STAs having a scan list to share may initiate a respective publish function. The publish function transmits a publish message to the subscribing apparatus 500 to make the subscribing apparatus aware that it has a scan list to share. FIG. 9 shows the publish message 904 transmitted at time t₁ by a second NAN concurrent STA 900. In some implementations, the second STA 900 subsequently transmits a paging message 906 to the apparatus 500 at time t₂ during a PW if it has buffered data available for the peer, for example, the requested scan list. In response to receiving the paging message, the apparatus 500 may transmit, at time t₃, a trigger message to the second STA 900 to trigger the second STA 900 to transmit the scan list. The apparatus 500 then remains awake during the subsequent TxW to receive the scan list. In response to the trigger message 908, the second STA 900 transmits a data message 910 that includes the scan list at time t₄ during the TxW.

In some other implementations, for example, if the apparatus 500 and the second STA 900 are wirelessly connected via an S-NDL, the second STA 900 may transmit the data message 910 including the scan list without transmitting a paging message in advance.

The process 800 proceeds in block 806 with the apparatus 500 receiving scanning information, for example, in the form of the scan list transmitted in the data message 910. In some implementations, the apparatus 500 then updates its scan list in block 808 based on the received scan list. For example, the apparatus 500 may merge its existing scan list with the received scan list. In some implementations, updating the scan list in block 808 may involve adding the frequency channels identified in the received scan list to the existing scan list. In some such implementations, updating the scan list may further involve adding identifiers or other information associated with APs operating on the identified channels. In some implementations in which the apparatus 500 does not have an existing scan list, updating the scan list at 808 can include storing the received scan list as the updated scan list.

The process 800 proceeds in block 810 with the apparatus 500 performing a scan based on the scan list. In some implementations, the scan performed in block 810 is a selective or targeted scan in which only the frequency channels identified in the updated scan list are scanned. In some instances, the scan performed in block 810 may include passive or active scans in one or more frequency bands (such as, for example, the 2.4 GHz, 5 GHz, 6 GHz or 60 GHz bands) to discovery one or more APs operating on each of the channels identified in the scan list. For example, and as shown in FIG. 9, the apparatus 500 may send a probe request 912 at time t₅ on one of the frequency channels identified in the scan list. An AP 901 operating on the channel being scanned may receive the probe request 912 and, responsive to the probe request, transmit a probe response 914 at time t₆.

In some implementations, the apparatus 500 may additionally update its scan list based on the scanning information obtained in block 810. In this way, the apparatus 500 also can publish and share an updated scan list with other STAs in response to receiving subscribe messages requesting such sharing.

The apparatus 500 then selects, in block 812, an AP with which to associate based on the scanning information obtained in block 810. For example, the apparatus 500 may select the AP 901 from among other identified APs operating on the identified channels based on the scanning information obtained in block 810, including, for example, RSSIs, supported data rates, parameter sets and capability requirements associated with the respective APs.

The process 800 proceeds in block 814 with the apparatus 500 associating with the selected AP 901. For example, the apparatus can transmit an association request 916 to the selected AP 901 at time t₇. In response to receiving the association request 916 and authenticating the apparatus 500, the AP 901 may then transmit an association response 918 to the apparatus 500 at time t₈ to complete the association.

In some other implementations, a NAN-compliant STA such as the apparatus 500 may periodically initiate the subscribe function to transmit subscribe messages requesting scan lists from neighboring STAs such that, in response to determining to initiate a scanning operation, the apparatus 500 already has an up-to-date scan list including identifications of available APs in its vicinity with which it may associate.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication comprising:
receiving, by a first wireless communication device, scanning information from a second wireless communication device over a wireless link associated with a first wireless communications protocol, the scanning information identifying one or more wireless frequency channels associated with a second wireless communications protocol;
selecting, by the first wireless communication device, a subset of wireless channels associated with the second wireless communications protocol based on the scanning information; and
scanning, by the first wireless communication device, one or more wireless frequency channels of only the selected subset of wireless frequency channels.

2. The method of claim 1, wherein the first wireless communications protocol is based on a Wi-Fi Alliance Neighbor Awareness Networking (NAN) standard specification and the second wireless communications protocol is based on an Institute of Electrical and Electronics Engineers (IEEE) 802.11 standard specification.

3. The method of claim 1, further including:
determining to initiate a scanning operation; and
responsive to determining to initiate the scanning operation, transmitting a subscribe request requesting the scanning information to the second wireless communication device over a wireless link associated with the first wireless communications protocol.

4. The method of claim 1, wherein the scanning information further includes, for each of the identified wireless frequency channels, one or more of: a service set identifier (SSID) associated with a wireless network, a received signal strength indicator (RSSI) associated with the wireless network, one or more supported data rates of the wireless network, one or more parameters associated with the wireless network, or one or more capability requirements of the wireless network.

5. The method of claim 1, further including generating or updating a scan list to include the one or more identified wireless frequency channels.

6. The method of claim 1, further including:
discovering one or more wireless access points (APs) on the one or more scanned wireless channels;
selecting a wireless AP from the discovered one or more wireless APs; and
performing an association operation to associate with the selected wireless AP.

7. The method of claim 6, further including generating or updating a scan list to include information associated with one or more of the discovered APs.

8. The method of claim 7, further including:
receiving a subscribe message from a third wireless communication device over a wireless link associated with the first wireless communications protocol; and
responsive to receiving the subscribe message, transmitting information in the scan list to the third wireless communication device over a wireless link associated with the first wireless communications protocol.

9. The method of claim 8, further including transmitting a publish message identifying that the first wireless communications device has scanning information to provide over a wireless link associated with the first wireless communications protocol.

10. A method for wireless communication comprising:
scanning, by a first wireless communication device, a plurality of wireless frequency channels in one or more frequency bands associated with one or more first wireless communications protocols;
identifying, by the first wireless communication device, a subset of the plurality of scanned wireless frequency channels on which one or more access points (APs) are operating; and
transmitting, by the first wireless communication device, scanning information including the identified subset of wireless frequency channels to a second wireless communication device over a wireless link associated with a second wireless communications protocol.

11. The method of claim 10, wherein the one or more first wireless communications protocols include a wireless communications protocol based on an Institute of Electrical and Electronics Engineers (IEEE) 802.11 standard specification and the second wireless communications protocol is based on a Wi-Fi Alliance Neighbor Awareness Networking (NAN) standard specification.

12. The method of claim 10, further including transmitting a publish message identifying that the first wireless communications device has scanning information to provide over a wireless link associated with the second wireless communications protocol.

13. The method of claim 10, further including receiving a subscribe message from the second wireless communication device over a wireless link associated with the second wireless communications protocol, wherein the transmission of the scanning information is responsive to receiving the subscribe message.

14. The method of claim 10, further including generating or updating a scan list to include the one or more identified wireless frequency channels.

15. The method of claim 10, wherein the scanning information further includes, for each of the identified wireless frequency channels, one or more of: a service set identifier (SSID) associated with a wireless network, a received signal strength indicator (RSSI) associated with the wireless network, one or more supported data rates of the wireless network, one or more parameters associated with the wireless network, or one or more capability requirements of the wireless network.

16. A wireless communications device comprising:
at least one antenna;
a processor; and
a memory communicatively coupled with the processor and storing processor-readable code that, when executed by the processor, causes the wireless communications device to:
receive scanning information from a second wireless communication device over a wireless link associated with a first wireless communications protocol, the scanning information identifying one or more wireless frequency channels associated with a second wireless communications protocol;
select a subset of wireless channels associated with the second wireless communications protocol based on the scanning information; and
scan one or more wireless frequency channels of only the selected subset of wireless frequency channels.

17. The wireless communications device of claim 16, wherein the first wireless communications protocol is based on a Wi-Fi Alliance Neighbor Awareness Networking (NAN) standard specification and the second wireless communications protocol is based on an Institute of Electrical and Electronics Engineers (IEEE) 802.11 standard specification.

18. The wireless communications device of claim 16, wherein the code is further configured to cause the wireless communications device to:
determine to initiate a scanning operation; and
responsive to determining to initiate the scanning operation, transmit a subscribe request requesting the scanning information to the second wireless communication device over a wireless link associated with the first wireless communications protocol.

19. The wireless communications device of claim 16, wherein the scanning information further includes, for each of the identified wireless frequency channels, one or more of: a service set identifier (SSID) associated with a wireless network, a received signal strength indicator (RSSI) associated with the wireless network, one or more supported data rates of the wireless network, one or more parameters associated with the wireless network, or one or more capability requirements of the wireless network.

20. The wireless communications device of claim 16, wherein the code is further configured to cause the wireless communications device to generate or update a scan list to include the one or more identified wireless frequency channels.

21. A wireless communications device comprising:
at least one antenna;
a processor; and
a memory communicatively coupled with the processor and storing processor-readable code that, when executed by the processor, causes the wireless communications device to:
scan a plurality of wireless frequency channels in one or more frequency bands associated with one or more first wireless communications protocols;
identify a subset of the plurality of scanned wireless frequency channels on which one or more access points (APs) are operating; and
transmit scanning information including the identified subset of wireless frequency channels to a second wireless communication device over a wireless link associated with a second wireless communications protocol.

22. The wireless communications device of claim 21, wherein the one or more first wireless communications protocols include a wireless communications protocol based on an Institute of Electrical and Electronics Engineers (IEEE) 802.11 standard specification and the second wireless communications protocol is based on a Wi-Fi Alliance Neighbor Awareness Networking (NAN) standard specification.

23. The wireless communications device of claim 21, wherein the code is further configured to cause the wireless communications device to transmit a publish message identifying that the first wireless communications device has scanning information to provide over a wireless link associated with the second wireless communications protocol.

24. The wireless communications device of claim 21, wherein the code is further configured to cause the wireless communications device to receive a subscribe message from the second wireless communication device over a wireless link associated with the second wireless communications protocol, wherein the transmission of the scanning information is responsive to receiving the subscribe message.

25. The wireless communications device of claim 21, wherein the code is further configured to cause the wireless communications device to generate or update a scan list to include the one or more identified wireless frequency channels.

26. The wireless communications device of claim 21, wherein the scanning information further includes, for each of the identified wireless frequency channels, one or more of: a service set identifier (SSID) associated with a wireless network, a received signal strength indicator (RSSI) associated with the wireless network, one or more supported data rates of the wireless network, one or more parameters associated with the wireless network, or one or more capability requirements of the wireless network.

27. A tangible computer-readable storage medium comprising non-transitory processor-executable code operable to:
receive scanning information from a second wireless communication device over a wireless link associated with a first wireless communications protocol, the scanning information identifying one or more wireless frequency channels associated with a second wireless communications protocol;
select a subset of wireless channels associated with the second wireless communications protocol based on the scanning information; and
scan one or more wireless frequency channels of only the selected subset of wireless frequency channels.

28. The storage medium of claim 27, wherein the first wireless communications protocol is based on a Wi-Fi Alliance Neighbor Awareness Networking (NAN) standard specification and the second wireless communications protocol is based on an Institute of Electrical and Electronics Engineers (IEEE) 802.11 standard specification.

29. The storage medium of claim 27, wherein the code is further configured to cause the wireless communications device to:
determine to initiate a scanning operation; and
responsive to determining to initiate the scanning operation, transmit a subscribe request requesting the scanning information to the second wireless communication device over a wireless link associated with the first wireless communications protocol.

30. The storage medium of claim 27, wherein the code is further configured to cause the wireless communications device to generate or update a scan list to include the one or more identified wireless frequency channels.

31. A tangible computer-readable storage medium comprising non-transitory processor-executable code operable to:
scan a plurality of wireless frequency channels in one or more frequency bands associated with one or more first wireless communications protocols;
identify a subset of the plurality of scanned wireless frequency channels on which one or more access points (APs) are operating; and
transmit scanning information including the identified subset of wireless frequency channels to a second wireless communication device over a wireless link associated with a second wireless communications protocol.

32. The storage medium of claim 31, wherein the one or more first wireless communications protocols include a wireless communications protocol based on an Institute of Electrical and Electronics Engineers (IEEE) 802.11 standard specification and the second wireless communications protocol is based on a Wi-Fi Alliance Neighbor Awareness Networking (NAN) standard specification.

33. The storage medium of claim 31, wherein the code is further configured to cause the wireless communications device to transmit a publish message identifying that the first wireless communications device has scanning information to provide over a wireless link associated with the second wireless communications protocol.

34. The storage medium of claim 31, wherein the code is further configured to cause the wireless communications device to receive a subscribe message from the second wireless communication device over a wireless link associated with the second wireless communications protocol, wherein the transmission of the scanning information is responsive to receiving the subscribe message.

35. The storage medium of claim 31, wherein the code is further configured to cause the wireless communications device to generate or update a scan list to include the one or more identified wireless frequency channels.
